(19) United States
(12) Patent Application Publication
(10) Pub. No.: US 2011/0106712 A1
(43) Pub. Date: May 5, 2011

(54) Cost-Aware Service Aggregation

(75) Inventors: Martin CALSYN, Cambridge (GB); Andreas HEIL, Linkenheim (DE); Vassily LYUTSAREV, Cambridge (GB); Alexandre BRÄNDLE, Cambridge (GB)

(73) Assignee: Microsoft Corporation, Redmond, WA (US)

(21) Appl. No.: 12/610,707

(22) Filed: Nov. 2, 2009

(51) Int. Cl. G06Q 10/00; G06Q 50/00

(52) U.S. Cl. 705/300; 705/301

(57) ABSTRACT

Cost aware service aggregation is described; for example, two or more web services may be connected to form an aggregate service in a way which minimizes computational costs and/or costs of network resources between the services. In an embodiment a service has a two or more contracts expressed using process-algebra which capture data representations and protocols of the web service. In an embodiment, a static analysis engine identifies combinations of contracts which are compatible according to the process-algebra. In an example, the identified combinations of contracts are ranked by cost to select an optimal combination. In other examples, network environment conditions are taken into account and dynamic adjustments made to the aggregation. In more examples, mappings of the data representations to other data representations are considered and appropriate proxy services are automatically used to implement these mappings if required.

### BACKGROUND

In many application domains it is required to connect individual services together to form aggregated services. However, it is difficult for programmers to determine whether any two services will successfully interoperate. Methods for connecting services such as web services have been proposed in which each service is assigned a contract expressed using process algebra and a static analysis of the contracts (using process algebra techniques) is carried out to identify compatible web services. In this way distributed services may be built across decentralized and heterogeneous systems. By specifying a single contract for each service and by carrying out the static analysis the aim is to form an aggregated service from individual services in such a way that issues of deadlocks, livelocks, race conditions, failures and exceptions, and failures of concurrency and asynchrony are minimized. Typically the results of the static analysis may be provided to a developer to help him or her identify services which are compatible; that is, the process occurs prior to run time.

Existing tools for identifying compatible services are limited in many respects. For example, existing methods of defining contracts often do not have sufficient expressiveness or they become very repetitive, verbose and tedious to use for all but the simplest situations. Also, many such existing tools are unable to take various factors into account that are important when considering design of aggregated services.

The embodiments described below are not limited to implementations which solve any or all of the disadvantages of known service aggregation tools.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

Cost aware service aggregation is described; for example, two or more web services may be connected to form an aggregate service in a way which minimizes computational costs and/or costs of network resources between the services. In an embodiment a service has a two or more contracts expressed using process-algebra which capture data representations and protocols of the web service. In an embodiment, a static analysis engine identifies combinations of contracts which are compatible according to the process-algebra. In an example, the identified combinations of contracts are ranked by cost to select an optimal combination. In other examples, network environment conditions are taken into account and dynamic adjustments made to the aggregation. In more examples, mappings of the data representations to other data representations are considered and appropriate proxy services are automatically used to implement these mappings if required.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a schematic diagram of an aggregated service formed from a plurality of distributed services;

FIG. 2 is a schematic diagram of two services to be connected to form an aggregated service and where each service has a plurality of contracts;

FIG. 3 is a flow diagram of a method of connecting two services;

FIG. 4 is a message sequence chart of an example method of connecting two services;

FIG. 5 is another message sequence chart of an example method of connecting two services using an intermediary;

FIG. 6 illustrates an exemplary computing-based device in which embodiments of a contract engine may be implemented.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

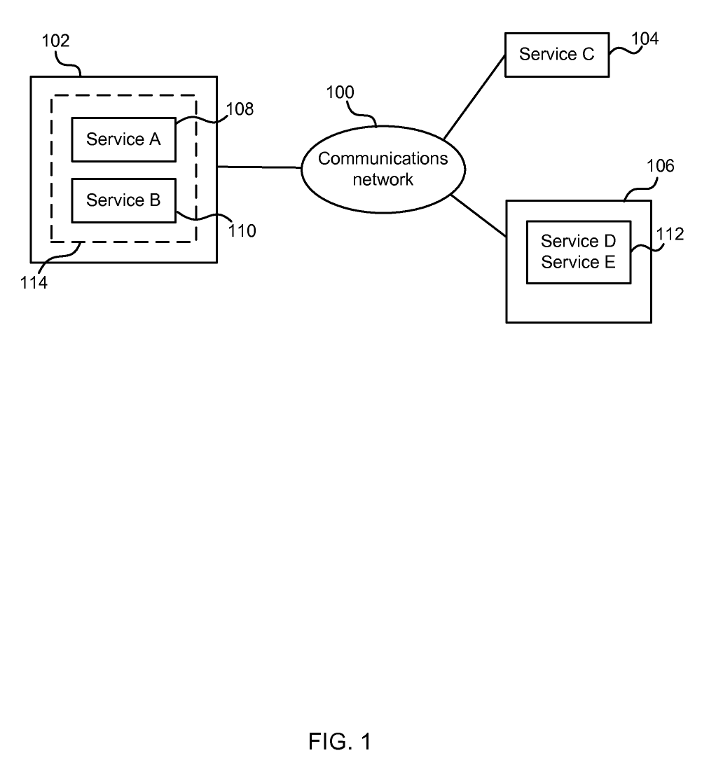

FIG. 1 is a schematic diagram of a plurality of services (A to D) which are distributed at various locations in a communications network 100. For example, service A and service B are provided on separate processors 108, 110 at a multi-core computer 102. In this example, services A and B are aggregated as indicated by the dotted line 114 such that they work together to complete a joint task. A service may be any piece of software that it is required to use in conjunction with another piece of software. A non-exhaustive list of examples of a service is: web service, data format transformation process, data source, data visualization component, analysis component, storage component, transport component, distributed computing component or components, aggregation component, distribution component, store-and-forward components and data buffers, compute agents, and various pipeline, workflow and queuing mechanisms.

In the example of FIG. 1 other services are provided such as service C which is provided at a remote processor 104 connected to the communications network 100. Services D and E may be provided at the same processor 112 or even within the same thread of a process at a given computer 106 connected to the communications network 100. Many other such services may be provided and services A to D are examples only.

For example, service A may be an application which receives user input specifying a geographical location and associated population. Service B may be an application which provides a bit map which is a graphical representation of the geographical location illustrating the population density over that geographical region. The aggregation of services A and B then provides a data visualization application. In another example, service A may be a customer service application which is arranged to purchase items from a merchant. Service B may be a merchant service application which is arranged to receive orders from the customer service application, take payment and deliver goods. By aggregating services A and B a two-party eProcurement application is obtained.

The services are computer-implemented and provided using any suitable hardware and software. The hardware used to provide the services may be distributed and may be heterogeneous.

At design time, when a programmer seeks to form an aggregated service it is not possible for the programmer to assess, for a given task, which combinations of services could successfully interoperate to perform the task. Furthermore, there may be a plurality of different ways in which any two services may successfully interoperate. For example, a service which provides a relational database table for example, may in one mode of operation provide the whole table. In another mode of operation it may provide a cursor into the table which enables a recipient of the cursor to read forwards or backwards in the table from that cursor. In another mode of operation it may provide a handle to the table. In order to address this each service is provided with a plurality of contracts which are declared at design time, with one contract for each mode of operation of the service. Each contract is assigned a cost such as “high level cost”, “medium level cost” and “low level cost” where the cost is declared as part of the contract. The cost captures information about the amount of computational and/or communications resources required for the service to operate in the given mode. By using a plurality of contracts for each service in this way it is possible to take into account different modes of operation of a service which have different cost levels. However, the number of possible combinations of services (and the operation modes) which can then be used to form a desired aggregated service is now much greater than in cases where only one contract is used per service. Also, it is no longer straightforward to select which of these large number of possible combinations to use for a particular desired aggregated service. In some embodiments described herein this is addressed by enabling a negotiation to take place between services and/or between agents associated with those services. In some embodiments this negotiation takes into account communications network conditions and/or other environmental conditions of the services.

Each contract comprises one or more process-algebra expressions which define a protocol that the service uses to interoperate with other services. A protocol within a service contract is a definition of the types of messages that may be sent and received by that service and the order in which they may be sent and received. By analogy, a seller and customer have a contract with each other. That contract specifies what is to be exchanged (product and forms of payment) and the ordering of the exchanges including accounting for credit versus cash payments and the handling of change and receipts. Likewise, a service contract specifies what is to be exchanged and in what order while accounting for variations based on what has happened so far.

In the example of a service mentioned above which provides a relational database table there may be three contracts. A first contract may specify that the data representation to be exchanged between services comprises a relational database table. A second alternative contract may specify that the data representation comprises a cursor into a relational database table. A third alternative contract may specify that the data representation comprises a handle to a relational database table.

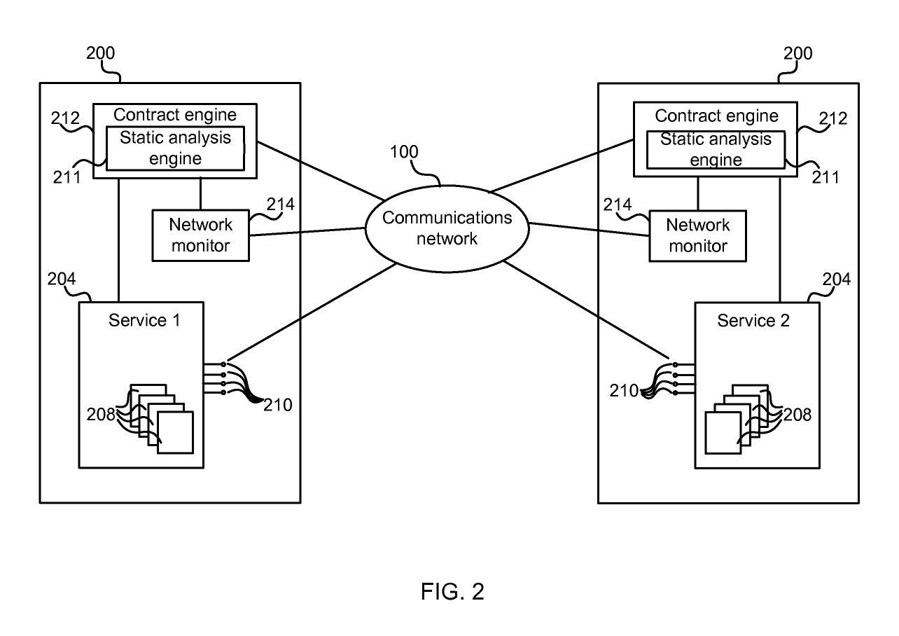

FIG. 2 is a schematic diagram of two services 204, 206 which are aggregated to perform a desired task. For example, the two services may be any of the two services illustrated in FIG. 1.

A first service 204, service 1 is provided as any suitable computer-implemented software located at an entity 200 in a communications network 100. A second service 206, service 2 is also provided as any suitable computer-implemented software located at an entity 202 in the communications network. The entities 200, 202 may be independent or integral and indeed the services may be computer-implemented at the same processor as described above with reference to FIG. 1.

In communication with each service 204, 206 is a contract engine 212. The contract engines may be standalone components or may be internal to the respective services. For example, a contract engine may be software provided as part of an operating system on a machine used to implement a service. In another example, a contract engine is provided as software integral with a service itself.

Each contract engine comprises (or is in communication with) a static analysis engine 211 for evaluating contracts expressed using process-algebra. Any suitable static analysis engine may be used which implements. any algorithm which can examine two or more process-algebra statements and return a compatibility indication.

In some embodiments, the contract engine comprises or is in communication with a network monitor 214 which monitors environmental conditions of the communications network 100 and of the services 204, 206. Network monitors 214 are shown in FIG. 2 for clarity although these are not essential.

In some embodiments the contract engine comprises a negotiation protocol for negotiating with other contract engines (which also comprise that same negotiation protocol) in order to select an optimal combination of contracts for use in forming a specified aggregated service. This negotiation protocol may comprise rules, thresholds, utility functions or other specified criteria which are used in selecting a particular combination of contracts.

Each service has two or more contracts which are declared by a programmer or using an automated tool. In some examples a service may have only one contract. In the example illustrated in FIG. 2 service 1 has four contracts 208 and service 2 has three contracts 208. As mentioned above, each contract captures information about an available protocol of the service. In the example of FIG. 2 service 1 thus has four protocols 210 (one for each contract) which may be used for connecting the service to one or more other services. Service 2 has three protocols 210. In the example illustrated in FIG. 2 one protocol from each service has been selected and used to establish a communications link between service 1 and service 2 via the communications network 100 as shown. In this way service 1 and service 2 are aggregated by means of that link.

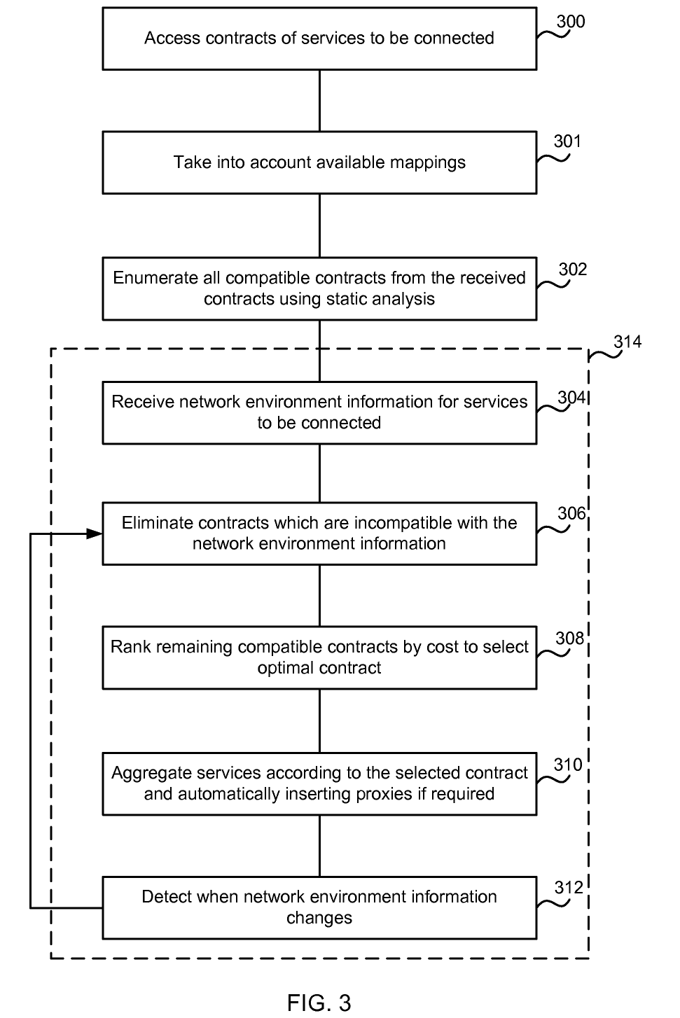

FIG. 3 is a flow diagram of a method at a contract engine such as either of the contract engines 212 of FIG. 2. The contract engine receives information identifying services which are potentially to be aggregated. For example, this information may be provided by a designer or programmer who wishes to create a new aggregated service. A user interface may be provided by the contract engine which is arranged to present a graphical representation of services. The user interface may be arranged to enable a user to manipulate that graphical representation in order to link services graphically and thereby generate a request for a static analysis of the proposed service aggregation. The contract engine accesses 300 the contracts of the identified services. The contract engine is already aware of the contracts of its own associated service. It obtains the contracts of another service with which aggregation is proposed. For example, this may be done by sending a message to that other service requesting the contracts and receiving those in a reply message. However, this is not essential. The contracts may be obtained in any suitable manner. For example, another option is for the contracts to be broadcast or published in some well-known location.

As mentioned above a contract comprises data representations used or required by a service and the order in which those data representations will be exchanged between services. Additionally, meta-data outlining the transport requirements for the data to be exchanged must also either be well-known (i.e., obvious given the data type) or specified in the contract. The contract engine is able to take into account 301 available mappings of those data representations. For example, those mappings may be provided at other services known to the contract engine. In an example, a service may require a temperature in degrees Celsius as an input provided as a floating point number. A mapping may be available at another service to map a degrees Celsius floating point number to a degrees Fahrenheit floating point number. Another mapping may be available to map a floating point number to an integer. Other mappings may transform bit maps to other image formats and so on. When the contract engine takes into account the available mappings it can be thought of as creating more contracts for a given service.

A static analysis engine at the contract engine 212 enumerates 302 the possible compatible contract combinations from the contracts of the identified services (taking into account the available data representation mappings). A list of compatible contract combinations is thus obtained. In the case that two services are being aggregated each possible combination is a pair of contracts with one contract from each of the services to be aggregated.

The contract engine receives 304 network environment information from the network monitors 214. This information may be received directly from the network monitors 214 or may be communicated between contract engines using the negotiation protocol mentioned above. The network environment information may comprise information about traffic levels on the communications network, available communications network resources, or other indicators of communications network environment conditions. For example, if two services are part of the same thread executing on a processor then the network environment information will be very different than if two services are located on different computers at geographically remote locations linked via a packet-based communications network.

The contract engine eliminates 306 any contracts which are incompatible with the network environment information. For example, some data structures such as pointers to blocks of memory (also known as ‘handles’) cannot be transported over network links. Thus, certain contracts may be eliminated from consideration on the basis that their data cannot be transported given the available communication links.

In an example, the contract engine then ranks 308 the remaining compatible contracts by cost and selects an optimal contract combination on the basis of the cost ranking. The cost of a contract may either be declared or calculated as some function of the quantity of data to be exchanged, network speed, latency and availability and other cost factors such as the actual metered monetary cost of a communication channel or other artificial cost measures.

Other ways of selecting a contract combination to use may be employed. For example, the contract engine may comprise rules, thresholds, criteria and/or utility functions to enable this selection to be made automatically.

The services are then aggregated 310 according to the selected contract combination. Proxy services are automatically inserted if required. For example, if any of the available mappings that were taken into account 301 are used the appropriate proxy services to carry out those mappings are automatically inserted into the aggregation.

The contract engine continues to monitor the network environment using the network monitors 214 and in any other suitable manner. If a change is detected 312 then the method returns to step 306 and repeats. This enables changes in network environment conditions to be dynamically accounted for. For example, if a service in the aggregation fails or becomes unavailable, this change is automatically detected and another aggregation is automatically formed to carry out the desired aggregate task. In another example, a new connection becomes available such as when a computer comes into short range wireless communications range with a web enabled mobile telephone. In this case there is a change of network environment and the service aggregation may change depending on the relative cost of any service newly available over the wireless connection.

The steps of the method enclosed in dotted lines 314 may be carried out at run time although this is not essential.

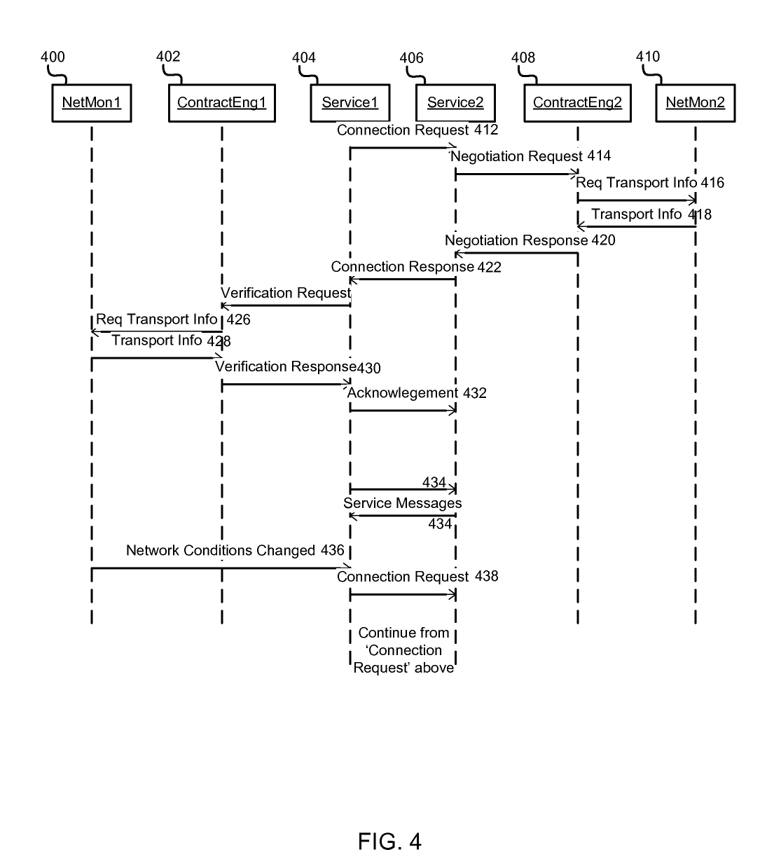

A detailed example of a negotiation between two contract engines is now given with respect to FIG. 4.

FIG. 4 is a message sequence chart schematically representing using vertical dotted lines two services and their respective contract engines and network monitors. Messages between those entities are illustrated by arrows where the direction of the arrows shows the direction of the messages and where the relative positions of the arrows on the diagram indicates the chronological sequence of those messages. Service 1 404 has an associated contract engine 402 and network monitor 400. Service 2 406 has an associated contract engine 408 and network monitor 410.

Suppose that it is required to aggregate services 1 and 2. Service 1 404 sends a connection request message 412 to service 2. The connection request message 412 contains all the contracts offered by service 1. Service 2 406 sends a negotiation request message 414 to its associated contract engine 408 with details of the contracts offered by service 1. Contract engine 408 sends a request message 416 to its associated network monitor 410 to request network environment information which is returned in message 418. Contract engine 2 then selects a contract match and returns that in a negotiation response message 420 to service 2. Service 2 sends the selected contract match to service 1 using a connection response message 422.

Service 1 404 passes the connection response to contract engine 1 402 for verification using verification request message 424. Contract engine 1 obtains current network environment information by sending a request message 426 to the network monitor 400 and receiving a response 428. Contract engine 1 is then able to accept the contract match passed to it in the verification request 424. Alternatively, it is able to reject that contract match and offer an alternative. In the example of FIG. 4 contact engine 1 accepts the contract match passed to it in the verification request 424. This acceptance is sent in verification response 430 and an acknowledgement message 432 is then passed from service 1 to service 2.

Service 1 and service 2 are now aggregated using the selected contract match and an exchange of service messages using the protocol of the selected contract match may occur 434.

If the network conditions change or a connection failure occurs this is detected by the network monitor(s). For example, network monitor 400 detects a change and sends information about this change to service 1 using message 436. Service 1 is then able to dynamically trigger a re-negotiation of the contract match by sending a connection request 438 to service 2. In this case the method then repeats from the connection request message 412 of FIG. 4.

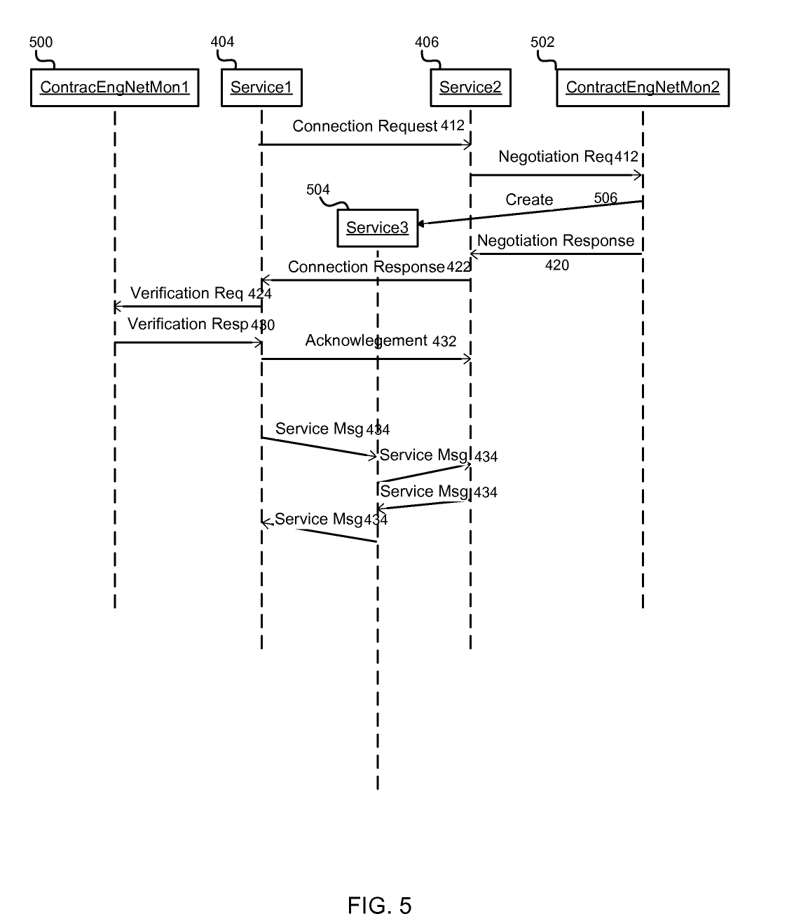

FIG. 5 is a message sequence chart in the same manner as FIG. 4. In this example the contract engines and network monitors are illustrated as integrated into a single entity for clarity. Service 1 404 and service 2 406 are to be aggregated. Service 1 has associated contract engine 1 500 and service 2 has associated contract engine 2 502.

Service 1 sends a connection request 412 to service 2 and service 2 makes a negotiation request 414 to its contract engine in the same manner as in FIG. 4. In this case a connection will require an intermediary service 504 to either change a data type or protocol pattern into a form that allows communication. Contract engine 2 starts 506 the intermediary service and returns a unique identifier of that intermediary service as part of the chosen contract match in the negotiation response and also as part of all the alternative contract matches.

Service 2 sends a connection response 422 to service 1 which carries out verification with its contract engine 500 using messages 424 and 430 as described with reference to FIG. 4. Service 1 acknowledges 432 the connection response and the two services are now aggregated via the intermediary service 3 504. Service messages 434 may then be exchanged via the intermediary as illustrated.

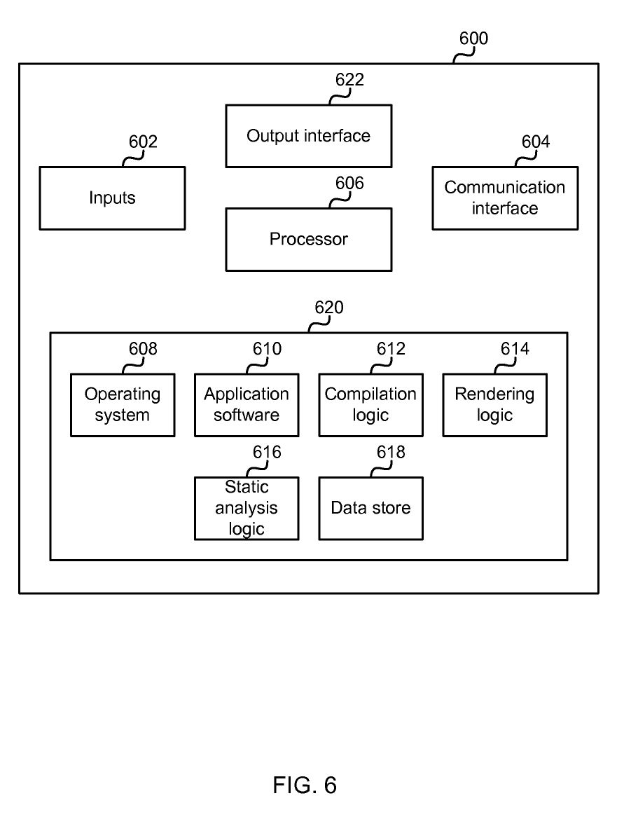

FIG. 6 illustrates various components of an exemplary computing-based device 600 which may be implemented as any form of a computing and/or electronic device, and in which embodiments of a cost aware service aggregation system may be implemented.

The computing-based device 600 comprises one or more inputs 602 which are of any suitable type for receiving media content, Internet Protocol (IP) input, service messages, service negotiation messages and other input. The device also comprises communication interface 604 suitable for enabling the device to communicate with other entities over a communications network of any type.

Computing-based device 600 also comprises one or more processors 606 which may be microprocessors, controllers or any other suitable type of processors for processing computing executable instructions to control the operation of the device in order to carry out cost aware service aggregation. Platform software comprising an operating system 608 or any other suitable platform software may be provided at the computing-based device to enable application software 610 to be executed on the device.

The computer executable instructions may be provided using any computer-readable media, such as memory 620. The memory is of any suitable type such as random access memory (RAM), a disk storage device of any type such as a magnetic or optical storage device, a hard disk drive, or a CD, DVD or other disc drive. Flash memory, EPROM or EEPROM may also be used. The memory may store software arranged to provide a contract engine 612; a network monitor 614 and static analysis logic 616. The memory also comprises a data store 618.

An output 622 is also provided such as an audio and/or video output to a display system integral with or in communication with the computing-based device. The display system may provide a graphical user interface, or other user interface of any suitable type although this is not essential.

The term ‘computer’ is used herein to refer to any device with processing capability such that it can execute instructions. Those skilled in the art will realize that such processing capabilities are incorporated into many different devices and therefore the term ‘computer’ includes PCs, servers, mobile telephones, personal digital assistants and many other devices.

The methods described herein may be performed by software in machine readable form on a tangible storage medium. The software can be suitable for execution on a parallel processor or a serial processor such that the method steps may be carried out in any suitable order, or simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Any range or device value given herein may be extended or altered without losing the effect sought, as will be apparent to the skilled person.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

It will be understood that the above description of a preferred embodiment is given by way of example only and that various modifications may be made by those skilled in the art. The above specification, examples and data provide a complete description of the structure and use of exemplary embodiments of the invention. Although various embodiments of the invention have been described above with a certain degree of particularity, or with reference to one or more individual embodiments, those skilled in the art could make numerous alterations to the disclosed embodiments without departing from the spirit or scope of this invention.

1. A computer-implemented method of connecting a first service and a second service in order to provide an aggregate service the method comprising:
at the first service receiving a plurality of contracts of the second service and accessing a plurality of contracts of the first service; wherein each contract comprises process-algebra expressions specifying a protocol and data representations of the contract's associated service and wherein each contract also comprises a cost;
using a static analysis engine to enumerate compatible pairs of contracts each pair having a contract of the first service and a contract of the second service;
using a contract engine to select one of the compatible pairs of contracts on the basis of the costs provided in the contracts.

2. A method as claimed in claim 1 which further comprises, at the first service, taking into account specified mappings of the data representations of the contracts during the enumeration.

3. A method as claimed in claim 1 which further comprises, at the first service, taking into account specified mappings of the protocol during the enumeration.

4. A method as claimed in claim 1 wherein the first and second services are provided in a network environment and wherein the method further comprises receiving network environment information and eliminating contracts which are incompatible with that received information.

5. A method as claimed in claim 1 which further comprises connecting the first and second services according to the selected contract pair.

6. A method as claimed in claim 4 which further comprises detecting a change in the network environment, identifying compatible contracts which are consistent with the updated network environment and repeating the step of selecting one of the compatible pairs of contracts.

7. A method as claimed in claim 6 which is carried out dynamically during operation of the aggregate service.

8. A method as claimed in claim 1 which further comprises sending the selected pair of contracts to the second service and receiving from that second service either an acknowledgement that the selected pair of contracts is to be used or a offered alternative pair of contracts.

9. A method as claimed in claim 1 which further comprises sending all the compatible contract pairs to the second service together with an indication of the selected pair.

10. A computer-implemented method of connecting a first service and a second service in order to provide an aggregate service the method comprising:
at the first service receiving a plurality of contracts of the second service and accessing a plurality of contracts of the first service; wherein each contract comprises process-algebra expressions specifying a protocol and data representations of the contract's associated service and wherein each contract also comprises a cost;
using a static analysis engine to enumerate compatible pairs of contracts each pair having a contract of the first service and a contract of the second service;
using a network monitor to monitor a network environment of the first and second services;
using a contract engine to select one of the compatible pairs of contracts on the basis of the costs provided in the contracts and also on the basis of the monitored network environment.

11. A method as claimed in claim 10 which further comprises detecting a change in the network environment, identifying compatible contracts which are consistent with the updated network environment and repeating the step of selecting one of the compatible pairs of contracts.

12. A method as claimed in claim 11 which is carried out dynamically during operation of the aggregate service.

13. A method as claimed in claim 10 which further comprises connecting the first and second services according to the selected contract pair.

14. A method as claimed in claim 10 which further comprises, at the first service, taking into account specified mappings of the data representations of the contracts during the enumeration.

15. A method as claimed in claim 14 which further comprises connecting the first and second services via at least one proxy service according to the selected contract pair and any specified mappings taken into account.

16. A contract engine for connecting a first service and a second service in order to provide an aggregate service the engine comprising:
an input arranged to receive a plurality of contracts of the second service and to access a plurality of contracts of the first service;
a memory arranged to store the contracts each comprising process-algebra expressions specifying a protocol and data representations of that contract's associated service and wherein each contract also comprises a cost;
a static analysis engine arranged to enumerate compatible pairs of contracts according to the process algebra, each pair having a contract of the first service and a contract of the second service; and wherein the contract engine is arranged to select one of the compatible pairs of contracts on the basis of the costs provided in the contracts.

17. A contract engine as claimed in claim 16 wherein the static analysis engine is arranged to take into account specified mappings of the data representations of the contracts during the enumeration

18. A contract engine as claimed in claim 16 comprising a network monitor arranged to receive network environment information of the first and second services and wherein the contract engine is arranged to only select contracts which are compatible with that received information.

19. A contract engine as claimed in claim 18 wherein the network monitor is arranged to detect a change in the network environment, and wherein the contract engine is arranged to identify compatible contracts which are consistent with the updated network environment and to repeat the step of selecting one of the compatible pairs of contracts.

20. A contract engine as claimed in claim 19 which is arranged to operate dynamically during operation of the aggregate service.
